(19) United States
(12) Patent Application Publication
(10) Pub. No.: US 2017/0261438 A1
(43) Pub. Date: Sep. 14, 2017

(54) MULTI DIMENSIONAL SCANNING AND MATERIAL DEPOSITING APPARATUS FOR SURFACE RECTIFICATION

(71) Applicants: Murat Okçuoglu, Santa Barbara, CA (US); Emin Ali Ferhan SIPAHI, Istanbul (TR)

(72) Inventors: Murat Okçuoglu, Santa Barbara, CA (US); Emin Ali Ferhan SIPAHI, Istanbul (TR)

(21) Appl. No.: 15/064,423

(22) Filed: Mar. 8, 2016

(51) Int. Cl. G01N 21/88; B05D 5/00; G01N 19/08

(52) U.S. Cl. CPC G01N 21/8851; G01N 19/08; B05D 5/005

(57) ABSTRACT

A rectification device and a method of using the device for rectification of a surface defect including mounting an positioning the rectification device at least one of adjacent or covering a defect;, identifying the defect, acquiring, a multi dimensional topological grid profile of the defect, calculating a fill volume and distribution sequence, including but not limited to, material transfer order, deposit layer thickness, that will achieve surface continuity with the region around the defect, and filling the defect with a suitable filler using at least one precision guided filling head in one or more filling passes following the calculate fill sequence until surface continuity is achieved.

### BACKGROUND

This application relates to surface rectification of damage or defects and in particular to determining the size and shape of defects and filling them in an automated or semi-automated manner

Rectification of scratches and minor localized finish damage on class A surfaces such as automotive panels and other fine surfaces typically requires significant effort and time. Utilization of modern surface recognition and automated filling concepts may be of benefit for such rectification tasks

### SUMMARY

In some embodiments systems and methods may be provided for surface rectification, utilizing a plurality of movable heads for scanning a surface imperfection and its surrounding area of surface, utilizing pattern recognition sensing and algorithms to mathematically determine the missing material based on overall surface profile and utilizing the movable heads to deposit filling, finishing and sealing material to voids and imperfections for topological rectification to deliver surface continuity and restored contour. Furthermore, the pluralities of heads may be capable of depositing primer, dye and sealer for a complete cosmetic restoration.

In some embodiments, a method may be provided for rectification of a surface defect using a rectification device, the method comprising including mounting an positioning the rectification device at least one of adjacent or covering a defect, identifying the defect, acquiring, a multi dimensional topological grid profile of the defect, calculating a fill volume and distribution sequence, including but not limited to, material transfer order, deposit layer thickness, that will achieve surface continuity with the region around the defect, and filling the defect with a suitable filler using at least one precision guided filling head in one or more filling passes following the calculate fill sequence until surface continuity is achieved.

In some embodiments, a surface defect rectification device system may be provided including at least one adjustable mounting element, a user interface, at least one defect identification element, at least one 3D profiler/scanner, at least one precision guided filling head connectable to at least one reservoir of filler, and a system controller connected to and controlling the user interface, defect identification element, 3D profiler and filling head, wherein the device is placed at least one adjacent or covering a defect, the defect is identified and profiled, a filling sequence is calculated to achieve surface continuity over the defect and the defect is filled by one or more filling passes of the filling head executing the calculated fill sequence until the defect is filled and surface continuity is achieved.

Some embodiments may include performing a surface properties scan of the surface area around the defect to determine at least one of selecting or mixing a coating that matches the surface properties, and covering the filled defect with a suitable surface coat using at least one precision guided coating head in one or more coating passes.

Some embodiments may include at least one of sealing or curing of the filler material if needed with at least one of an optional filler curing or sealing head.

Some embodiments may include at least one of sealing or curing the coating material if needed with at least one of an optional coating curing or sealing head.

In some embodiments, the surface properties include at least one of color, tint, texture or reflectivity.

In some embodiments, defects rectified include paint chips, scratches in painted or unpainted metal, plastic, composites, wood, concrete, asphalt or masonry.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 shows a simplified schematic of an illustrative embodiment.

FIG. 2 shows an alternative arrangement of an illustrative embodiment.

FIG. 3 shows another alternative arrangement of an illustrative embodiment.

FIG. 4 shows a filling sequence according to an illustrative embodiment.

FIG. 5 is a flow chart of defect detection filling steps of a method according to an illustrative embodiment.

FIG. 6 is a flow chart of coating and finishing steps of a method according to an illustrative embodiment.

FIGS. 7A, and 7B show details of positioning elements according to an illustrative embodiment.

FIG. 8 depict an illustrative embodiment of a vehicle implementation.

### DETAILED DESCRIPTION

Generally described, aspects of the present disclosure relate to a rectification device including mechanical positioners of various types, optical detection and imaging systems, filling and/or printing devices, coating/painting devices, optional finishing devices, and control systems with user interfaces.

One or more embodiments described herein may provide for repairing scratches and minor localized finish damage on class A surfaces such as automotive panels and other fine surfaces without disproportionate work such as complete removal of existing finish, extensive surface preparation and obligatory repainting of entire panels.

One or more embodiments described herein may provide for surface rectification without employing the talent of a highly skilled and experienced craftsman for localized precision touch up work.

One or more embodiments described herein may provide a practical, scalable and operator independent solution for surface rectification.

One or more embodiments described herein may provide for surface rectification which fills in the voids or imperfections caused by scratches without overfilling, eliminating the additional steps of grinding and removal of excess material.

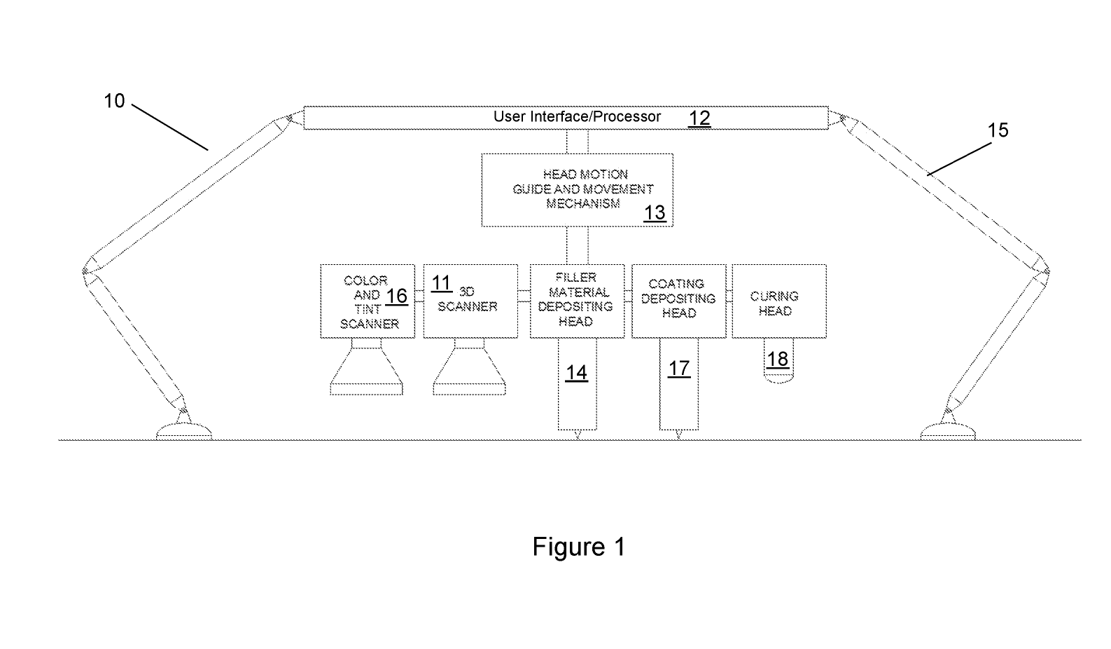

FIG. 1 shows various elements of an embodiment of a rectification device 10. By utilizing surface scanning technologies, the system uses at least one scan head 11 to scan the 3-dimensional topography surface to be treated, including undamaged adjacent surfaces, and creates a digital 3 dimensional topography. Using predictive algorithms, the system processor 12 calculates and determines the damage by comparing predicted intact surface and actual surface scan. Damaged area is identified and isolated by interpolating existing surface curvature and distinguishing void caused by damage. The damage dimensions and coordinates are thus precisely established.

Further scanning of adjacent undamaged surface properties may performed utilizing either the same scanner or optional special color and tint scanner 16 may determine surface qualities and properties such as color, tint, roughness, gloss and texture. Using this information, a print head 14 for depositing filler materials and optionally a separate coating depositing head 17 utilizing existing 2D and 3D printing methods, deposits suitable filling and finishing materials.

In an embodiment of the system, a curing head 18 may be utilized to accelerate or activate curing of deposited filler or coating materials. The processor 12 may also include a user interface. The void detection, color, tint, and texture identification may be accomplished under user control, fully automated or some mix of the two. The heads may be positioned using a guide and movement mechanism 13, which will be discussed in more detail below. In the embodiment of FIG. 1, system 10 is supported over a surface on support structure 15. For applications such as scratches on an automobile, support structure 15 may be legs, possibly articulated, covering an area of a few inches to a few feet in dimension, and with positioning mechanisms having a range of motion covering the area within the supports. Of course, much smaller or much larger area systems are possible as the various elements scale easily. One embodiment of a user interface is a typical video screen capable of displaying information, said screen being touch sensitive for receiving operator commands. Other forms of user interface may also be suitable. The preferred processor is a typical digital processor comprising of typical digital and analog input/output interfaces, an electronic processor, CPU, a digital volatile memory, a digital storage medium and operator interface. The operator interface displacing information in graphical format and receiving commands via one or more of the typical interfaces such as a touch screen, a pointing device, a keyboard.

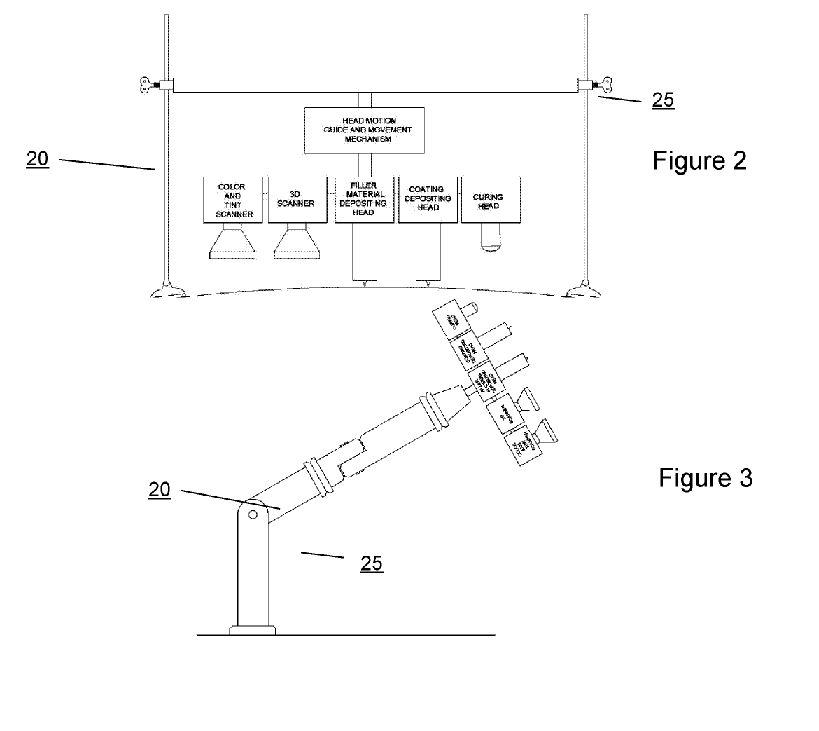

FIG. 2 illustrates another embodiment for the supporting legs 25 of the device 20. A plurality of at least 2 legs are constructed of straight rods with an articulated joint at the distal end attached to a suitable feet, preferably a rubber suction cup. The device is attached to the rods via sliding clamps with means to manually secure at the desired position height.

FIG. 3 illustrates another embodiment for the support and articulation of the device, in this embodiment, the device 20 is supported by a rigid primary post 25 that is rotatable around its own axis. A secondary post is attached to the primary post via an articulation rotatable in at least one plane. The secondary post may be jointed midsection to provide independent rotation of its distal end around its own axis. A third post is attached to the secondary post via an articulation rotatable in at least one plane. The third post may be jointed midstream to provide independent rotation of the distal end around the said post axis, with the invention head assembly attached to the distal end. The head attachment joint may be articulated in at least one axis. At least one, or in some embodiments, all, movable joints are actuated by a servo mechanism controlled by a digital processor and optionally equipped with angular position sensors for providing precise position feedback to said digital processor.

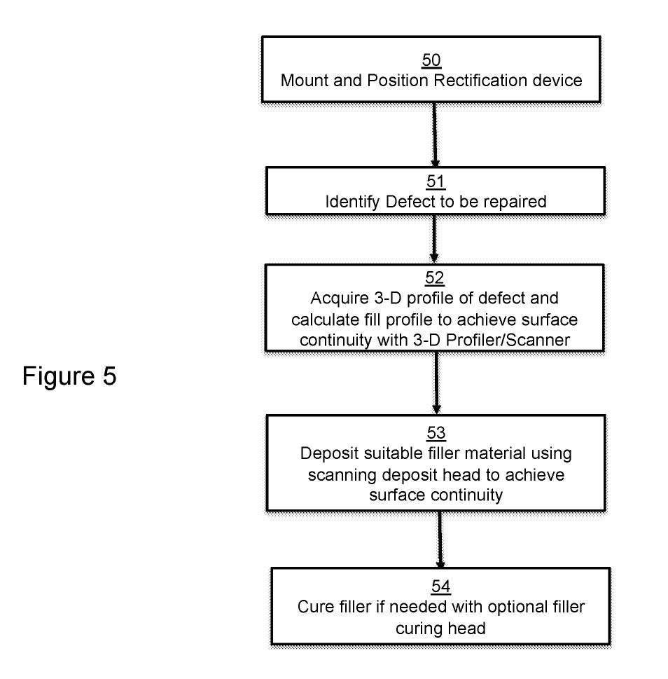

FIG. 5 illustrates a method of operation for a rectification system or device according to various disclosed embodiments. In step 50 the device is mounted and positioned adjacent an area to be repaired. In step 51 the defect is identified using either automated pattern recognition or with the aid of user assist through a user interface that allows a user to visually inspect a surface and select portions of the surface, either as the actual identification or to direct an automated identification to the correct region. In step 52 a 3-D profile of the defect is acquired and a fill profile to achieve surface continuity with surface adjacent the defect is calculated. Again both the profiling and fill determination may be accomplished algorithmically and automatically, or with some degree of user assistance.

In an exemplary embodiment, once the head assembly is manually positioned on or adjacent to a surface to be treated, the device is actuated by the operator to analyze the surface. The analysis starts by digitally scanning the target surface. Using at least one scan head, the device scans the entire target surface and internally forms a digital three dimensional topography. Scan head(s) may be automatically moved by the processor as necessary to obtain a complete scan. The digital topography obtained is then automatically analyzed by the algorithm to identify and isolate the defect or defects by detecting the surface discontinuity. The algorithm further detects and ignores natural surface features that are not defects such as designed contours or channels based on the premise that they have uniform contour and continuity as opposed to random or abrupt characteristics of a defect or damage. As necessary, using a user interface graphical display, the operator may double check the accuracy of automated assessment and if necessary, using the user interface, manually mark for inclusion or exclusion of areas selected by the algorithm to be treated.

In step 51, filler material is deposited by a scanning/filling/printing head according to the calculated profile. Step 52 is an optional curing step for fillers requiring cure.

Variants of surface rectification filler compounds suitable for manual surface repair work may be utilized. Such filler materials include various forms such as viscous liquids that harden by evaporative means, viscous liquids that harden by chemical means, viscous liquids that harden by thermal means, viscous liquids that harden by light exposure, including visible, ultraviolet or infrared wavelengths, coherent and laser beams, fine particles suspended in evaporative solvent base, fine dry particles that harden by thermal means, two or more part compounds that form composite fillers, two part epoxy compounds and other materials. The chemical or mechanical properties of the fillers may be altered for optimization to be dispensed by printheads, such as adjusting the viscosity, adjusting cure time or particle size or altering or substituting curing mechanisms. The filler material selection mat be based on end use requirements and may be application specific and the selection will be based on substrate, i.e. automotive panel rectification applications will require use of variants of automotive body fillers, road surface rectification will most likely use tar and sand based fillers.

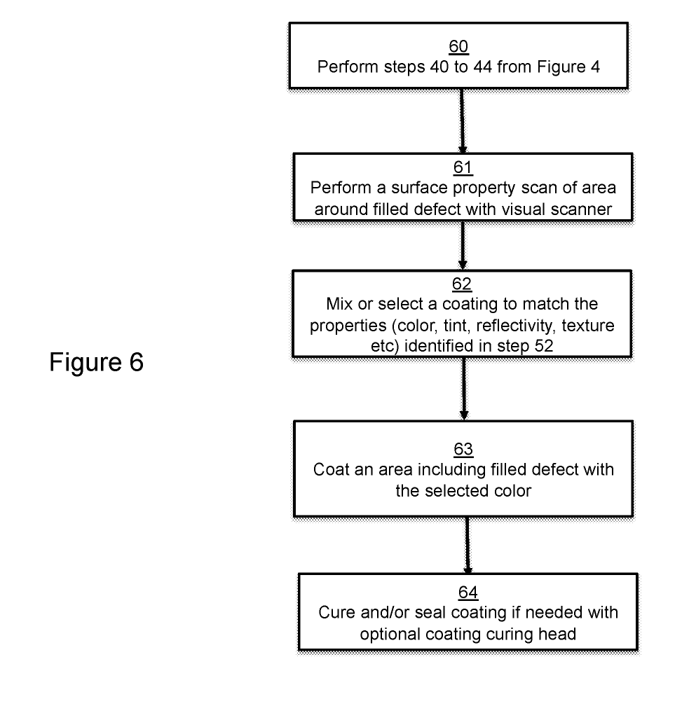

FIG. 6 illustrates coating steps to match color, texture and so on so the filler is indistinguishable from the adjacent surface. These steps are shown as separate coating functions in step 60 performed after the steps of FIG. 5, but it is to be understood that the filler itself may infused with colorizers as well and these steps could be done before the filling steps of FIG. 5. Step 61 is scan to determine the properties of the surface adjacent the defect, such as color, tint, texture etc, again either fully automated or with user assistance. Step 61 either selects or causes to be mixed a coating (or filler colorizing agent) that matches the adjacent surface. In step 63 the coating is applied to the defect and adjacent surface as needed (or added to the filler). Step 64 is an optional filling step. Surface property recognition such as detection and determination of color palette for paint matching utilizing digital sensors is known. The device uses existing sensing equipment to identify surface properties and utilizes color mixing technology to match color, tint and other properties. This is may be done by mixing base color paints with various tints and additives to match existing surface color, tint, sheen, etc. Texture information can be further utilized to replicate surface texture by manipulating depositing and curing heads to shape finished surface.

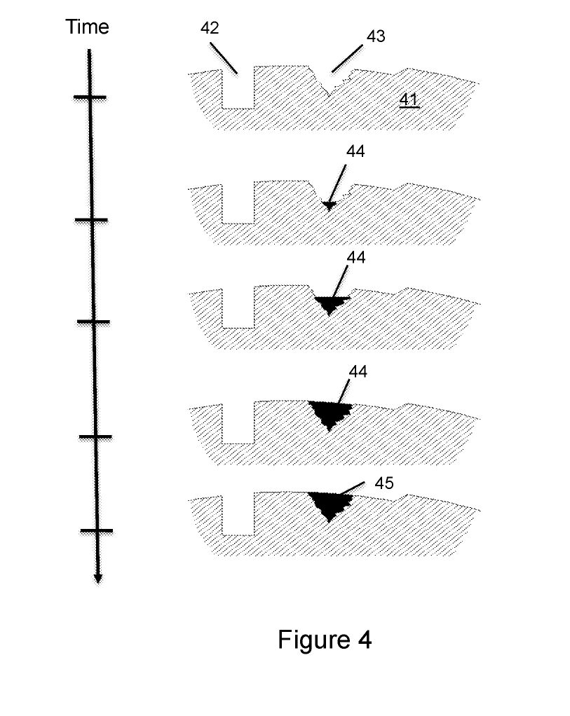

FIG. 4 is a cross-sectional view of a surface to be repaired 41, illustrating a defect 43 adjacent a surface feature 42 and shows the defect being 43 filled in a series of deposition or printing passes over time with deposited filler material 44 according to the disclosed embodiments. Optional coating finish 45 may be deposited once defect 43 is filled.

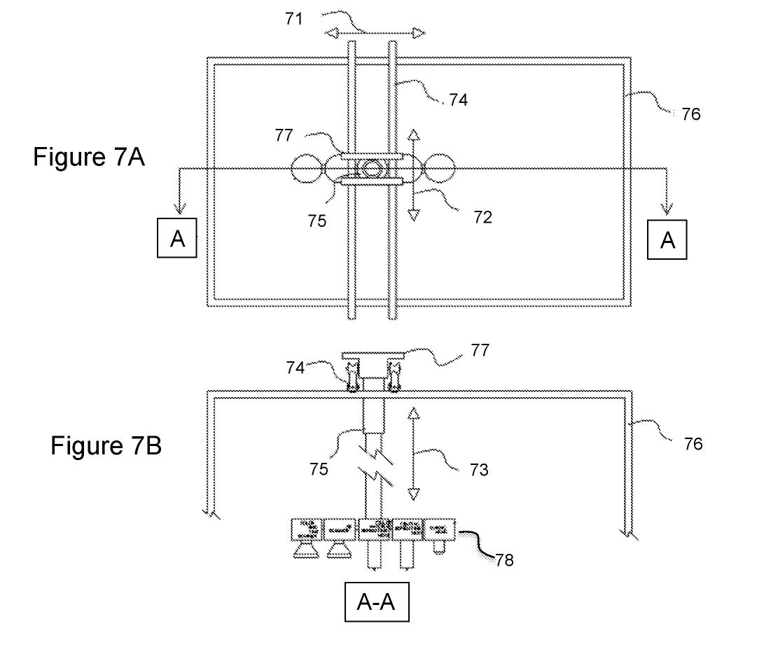

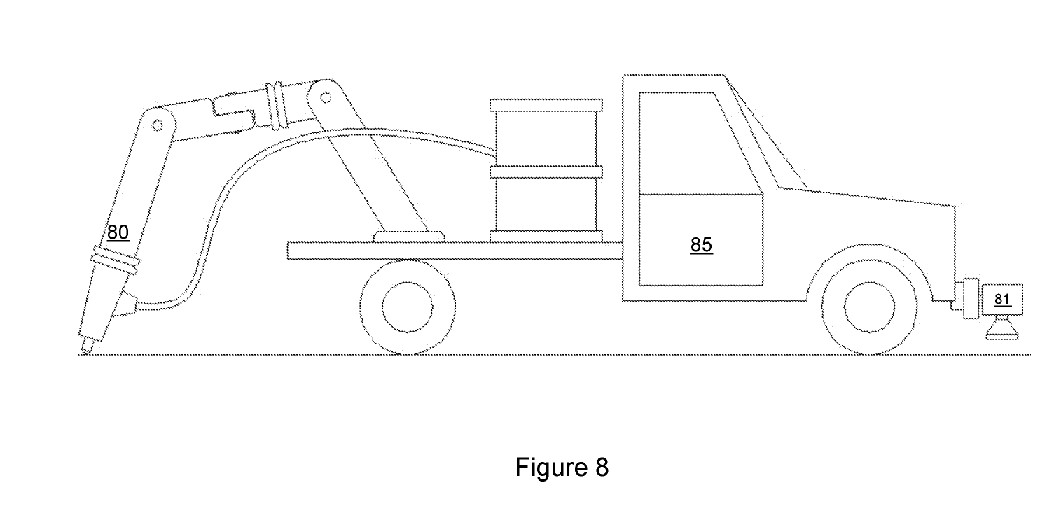

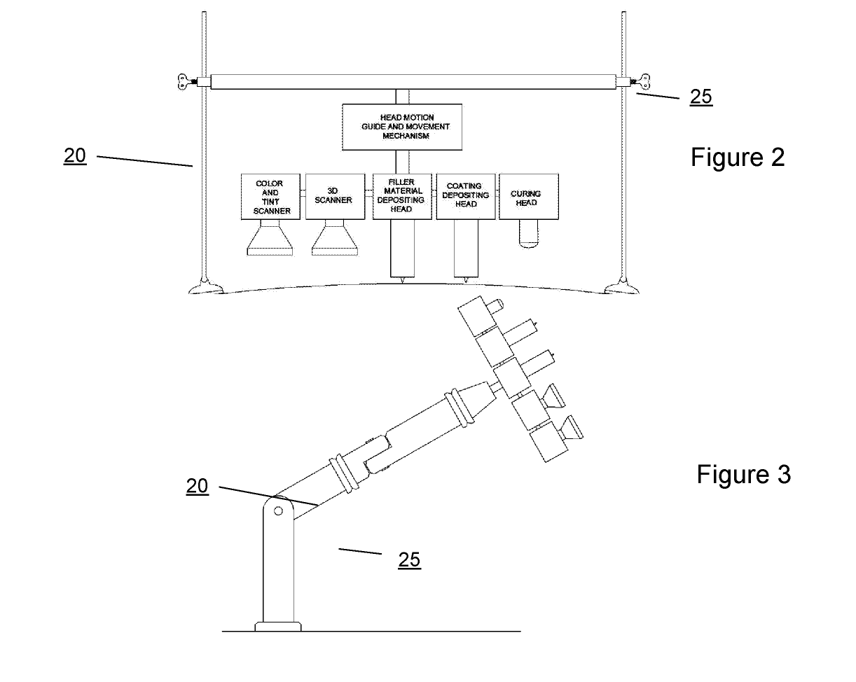

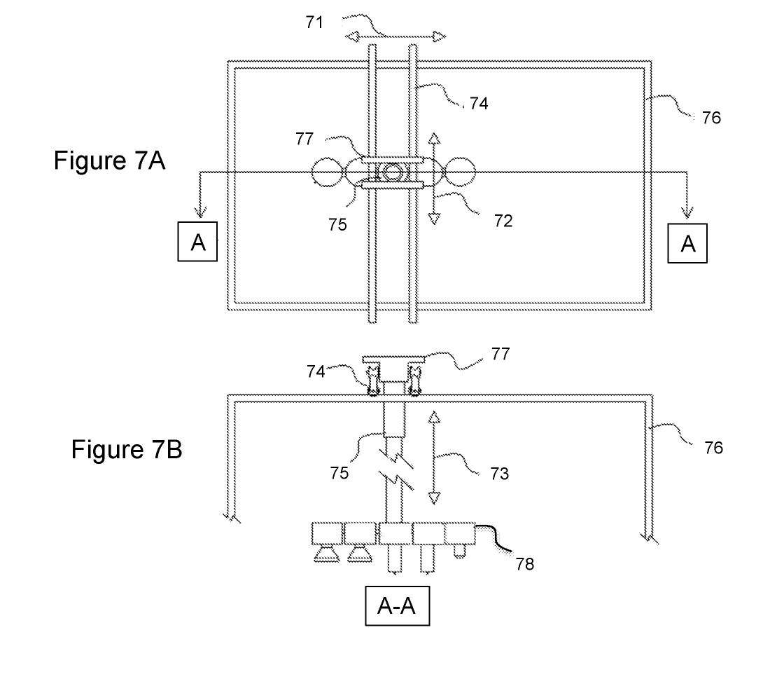

The scanning, printing, depositing and curing heads, head unit may be assembled together and move in tandem. The head unit position is altered by a plurality of actuators on a plurality of axes. Each motion axis current position may be detected by precision position encoders. A control processor detects and controls the motion of the head unit. Two views of an illustrative positioning embodiment are shown in FIGS. 7A and 7B

In one illustrative embodiment, the plural heads are articulated together in at least 3 perpendicular axes of motion, X 71, Y 72 and Z 73, Head motion in each axis may be actuated by an actuator. Position of the head in each axis may determined by a position encoder. Thus, the heads can be precisely positioned and moved to any coordinate within the range of motion of the device. The position encoders will provide the exact location of the heads to the control computer, and the control computer can control the position by commanding the actuators independently in each axis.

In another illustrative embodiment, X trolley 74, Y trolley 77 and Z trolley 75 are mutually perpendicular to each other and mounted to base 66 and each is rotatable on its own axis and actuated by a motor. An angular position encoder may be utilized to detect the precise angular position of the trolley, providing positional feedback to the control processor. Each trolley is attached to the base. On the distal end of each trolley, an articulated joint permit angular motion of an extension arm on at least one plane. The motion is actuated by a motor and the precise angular position of the arm is detected by an angular position encoder. A plurality of the arm and joints combinations may be utilized in series to increase head motion versatility and range. The head unit is positioned at the distal end of the arm and joint combinations. The combination of angular actuators are controlled by the control processor to drive and precisely position the individual heads to the desired location, where precise coordinate location information of the heads are provided to the control computer via angular encoders.

FIG. 7A is the top view of an embodiment of the head motion guide and movement mechanism, which is symbolically marked as item 13 on FIG. 1. FIG. 7B is the side view of the same. A rectangular frame 76 is utilized both as a support and guide. A pair of the opposing edges of the rectangular frame 76 provide one of three perpendicular guiding axis, 71. The carriage rail 74 slides on the said edges of frame 76 along the axis 71. The carriage rail 74 also forms the second of the three perpendicular axis of motion, 72. Cart 77 slides on carriage 74 along the axis 72. Axis 71 is perpendicular to axis 72. Both axis 71 and 72 are perpendicular to axis 73. Telescoping appendage 75 is attached to cart 77 on one distal end and carries the head assembly 78 on the other distal end. Telescoping appendage 75 telescopes to alter its length on the third of the three axis of motion, 73. Frame 76 is equipped with a suitable linear position sensor to communicate the exact linear position of Carriage rail 74 on axis 71 to the digital processor. Frame 76 is equipped with a suitable linear actuator to move Carriage rail 74 on axis 71 based on commands from the digital processor. Carriage rail 74 is equipped with a suitable linear position sensor to communicate the exact linear position of Cart 77 on axis 72 to the digital processor. Carriage rail 74 is equipped with a suitable linear actuator to move Cart 77 on axis 72 based on commands from the digital processor. Cart 77 is equipped with a suitable linear position sensor to communicate the exact linear position of head assembly 78 on axis 73 to the digital processor. Cart 77 is equipped with a suitable linear actuator to move head assembly 78 on axis 73 based on commands from the digital processor.

In another embodiment, a combination of the linear and said angular articulation mechanism may be utilized to optimize head unit motion for specific applications.

The 3-D profile surface topography scan information is utilized by the control processor to calculate optimal head motion and sequence to rectify the defect or damage. The surface property scan information is utilized by the control processor to calculate optimal filler material selection, optimal material deposit volume, optimal material deposit layer thickness, suitable surface coating selection, suitable coating material tint combinations to match desired visual surface properties including but not limited to color, tint and gloss. The control processor further determines and controls the speed and utilization of the heads to optimize surface rectification of the defect or damage, such as the use of additional coatings, clear coats, curing processes and application durations.

Thus, surface damages are repaired using printheads or other finely controlled filling devices to deposit filling, finishing and sealing materials, as required. Further treatment of the deposited materials, such as curing by infra red lighting, activating by ultra violet lighting, and curing by laser, can be utilized as necessary, using the articulating systems for precision guidance of the head unit assembly over determined surface damage area.

The concept proposed with said invention can be scaled for use in different uses of differing scales. FIG. 8 depicts such a use, such as repair and rectification of damage on road or pavement surfaces. In the preferred embodiment, an ordinary truck 85 is utilized as the movable supporting frame for the device. At least one scan head assembly 81 is positioned ahead of the deposit head assembly 80 to detect damage. While the truck is in motion on the surface to be treated, the scan head assembly 61 determines damage profile in 3D as well as the coordinates of the damage in three perpendicular axis with respect to the truck 85. A digital processor receives and processes the damage information from scan head assembly 81. The digital processor calculates the target coordinates based on scan data and truck speed data and directs the deposit head 80 servo mechanisms to correct position and trace the damage. Using the data collected by scan head assembly 81, the digital processor also calculates the amount of filler material to be deposited and the dispensing coordinates based on damage profile and location information provided by the scan head assembly 81. The digital processor directs the head assembly 80 to deposit proper amount of filler material at the calculated coordinates based on said data. In another embodiment of the invention, scan head 81 and deposit head 80 can be mounted on different vehicles, where the damage scan information is recorded and communicated utilizing absolute coordinates via global positioning satellite GPS system signals or other coordinate references. Such arrangement may help scanning and repairs to be done at different times or at different speeds

The embodiments described herein are exemplary. Modifications, rearrangements, substitute processes, etc. may be made to these embodiments and still be encompassed within the teachings set forth herein. One or more of the steps, processes, or methods described herein may be carried out by one or more processing and/or digital devices, suitably programmed.

Depending on the embodiment, certain acts, events, or functions of any of the embodiments described herein can be performed in a different sequence, can be added, merged, or left out altogether (e.g., not all described acts or events are necessary for the practice of the embodiment). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and method steps described in connection with the embodiments, including the control and/or digital processor, disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein, including the control processor, can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. For example, functions allocated to device identified as “PC” may be implemented using a discrete memory chip, a portion of memory in a microprocessor, flash, EPROM, or other types of memory, or computing device.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instructions.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A method for rectification of a surface defect using a rectification device, the method comprising:
mounting an positioning the rectification device at least one of adjacent or covering a defect;
identifying the defect;
acquiring, a multi dimensional topological grid profile of the defect;
calculating a fill volume and distribution sequence, including but not limited to, material transfer order, deposit layer thickness, that will achieve surface continuity with the region around the defect; and,
filling the defect with a suitable filler using at least one precision guided filling head in one or more filling passes following the calculate fill sequence until surface continuity is achieved.

2. The method of claim 1 further comprising:
Performing a surface properties scan of the surface area around the defect;
To determine at least one of selecting or mixing a coating that matches the surface properties; and
Covering the filled defect with a suitable surface coat using at least one precision guided coating head in one or more coating passes.

3. The method of claim 1 further comprising at least one of sealing or curing of the filler material if needed with at least one of an optional filler curing or sealing head.

4. The method of claim 2, further comprising at least one of sealing or curing the coating material if needed with at least one of an optional coating curing or sealing head.

5. The method of claim 2 wherein the surface properties include at least one of color, tint, texture or reflectivity.

6. The method of claim 4 wherein defects rectified include paint chips, scratches in painted or unpainted metal, plastic, composites, wood, concrete, asphalt or masonry.

7. A surface defect rectification device system comprising:
at least one adjustable mounting element;
a user interface;
at least one defect identification element;
at least one 3D profiler/scanner;
at least one precision guided filling head connectable to at least one reservoir of filler; and
a system controller connected to and controlling the user interface, defect identification element, 3D profiler and filling head;
wherein the device is placed at least one adjacent or covering a defect, the defect is identified and profiled, a filling sequence is calculated to achieve surface continuity over the defect and the defect is filled by one or more filling passes of the filling head executing the calculated fill sequence until the defect is filled and surface continuity is achieved.

8. The rectification system of claim 7, further comprising at least one of a filler curing or sealing head.

9. The rectification system of claim 7, further comprising a surface properties analysis element, at least one of a selection of coatings or a coatings mixer, and a precision guided coating head, wherein the surface properties of the region around the filled defect are analyzed and a suitable coating is at least one of selected or mixed and applied to the surface.

10. The rectification system of claim 9, further comprising at least one of a coating curing or sealing head.

11. The rectification system of claim 9, wherein the surface properties include at least one of color, tint, texture or reflectivity.

12. The rectification system of claim 11 wherein the surface analysis element is an optical color/texture analyzer.

13. The rectification system of claim 7, wherein the mounting elements are telescoping legs.

14. The rectification system of claim 7, wherein the mounting elements comprise supports with a frame carrying the other elements that cab be couple to the supports at selectable heights.

15. The rectification system of claim 7, wherein the mounting elements include suction feet.

16. The rectification system of claim 7, wherein defect identification element includes at least a visible imager and at least one of user location input and pattern recognition.

17. The rectification system of claim 7, wherein the 3D profiler is at least one of an optical profilometer, a stylus profilometer or an Atomic Force Microscope head.

18. The rectification system of claim 7, wherein device spans an area including defects of less than 24 inches in the longest dimension and preferably less than 12 inches.

19. The rectification system of claim 7, wherein the mounting elements comprise a wheeled vehicle carrying the profiler and filling heads, and the vehicle slowly travels with the profiler passing over defects first, scanning the defects and then the filling head passes oven and fills the defects

20. The rectification system of claim 7, wherein defects rectified include paint chips, scratches in painted or unpainted metal, plastic, composites, wood, concrete, asphalt or masonry.
